(19) United States
(12) Patent Application Publication
(10) Pub. No.: US 2026/0309239 A1
(43) Pub. Date: Oct. 8, 2026

(54) FLUID VALVE

(71) Applicant: Tsai-Chen YANG, Taichung City (TW)

(72) Inventor: Tsai-Chen YANG, Taichung City (TW)

(21) Appl. No.: 19/098,154

(22) Filed: Apr. 2, 2025

(51) Int. Cl. F16K 11/074; F16K 11/085; F16K 27/04; F16K 27/06

(52) U.S. Cl. CPC F16K 11/074; F16K 11/0853; F16K 27/045; F16K 27/065

(57) ABSTRACT

A fluid valve includes a valve seat, a mixing valve core and a diverter valve core. The valve seat includes a first accommodating portion, a hot water tube portion, a cold water tube portion, a connecting tube portion, a second accommodating portion and at least two outlet tube portions. The hot water tube portion and the cold water tube portion are communicated with an interior of the first accommodating portion, and the connecting tube portion is communicated with the interior of the first accommodating portion and an interior of the second accommodating portion. The second accommodating portion is communicated with the at least two outlet tube portions. The mixing valve core is received in the first accommodating portion, and the diverter valve core is received in the second accommodating portion. Therefore, the fluid valve provides both water mixing and diverter functions and is easy to install.

### BACKGROUND OF THE INVENTION

### Field of the Invention

The present invention relates to a fluid valve.

### Description of the Prior Art

A water valve is a device used to control the flow of water. It can be used to regulate water volume, water pressure, flow direction, mix water, and so on. It is widely applied in household water systems, industrial equipment, and various pipeline systems. Common types of water valves include, but are not limited to, ball valves, plug valves, butterfly valves, check valves, mixing valves, diverter valves, and others. Different types of valves with different functions are available for users to select and install to meet different requirements.

However, when two or more valves need to be installed, additional pipeline configuration is often required, leading to issues such as construction inconvenience and disorganized piping.

The present invention is, therefore, arisen to obviate or at least mitigate the above-mentioned disadvantages.

### SUMMARY OF THE INVENTION

The main object of the present invention is to provide a fluid valve, which provides both water mixing and diverter functions and is easy to install.

To achieve the above and other objects, the present invention provides a fluid valve, including: a valve seat, a mixing valve core and a diverter valve core. The valve seat includes a first accommodating portion, a hot water tube portion, a cold water tube portion, a connecting tube portion, a second accommodating portion and at least two outlet tube portions. The hot water tube portion and the cold water tube portion are respectively communicated with an interior of the first accommodating portion, and the connecting tube portion is communicated with the interior of the first accommodating portion and an interior of the second accommodating portion. The second accommodating portion is respectively communicated with the at least two outlet tube portions. The mixing valve core is received in the first accommodating portion, and the mixing valve core includes a hot water inlet, a cold water inlet and a first mixed water outlet. The hot water inlet is communicated with the hot water tube portion, the cold water inlet is communicated with the cold water tube portion, and the first mixed water outlet is communicated with the connecting tube portion. The diverter valve core is received in the second accommodating portion, and the diverter valve core includes at least one mixed water inlet and at least two second mixed water outlets. The at least one mixed water inlet is communicated with the interior of the second accommodating portion, and the at least two second mixed water outlets are respectively communicated with the at least two outlet tube portions.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a stereogram of a preferable embodiment of the present invention as viewed from another perspective;

FIG. 3 is a front view of FIG. 1;

FIG. 4 is a rear view of FIG. 1;

FIG. 5 is a right side view of FIG. 1;

FIG. 6 is a breakdown drawing of FIG. 1;

FIG. 7 is a stereogram of a portion of a valve seat according to a preferable embodiment of the present invention; and

FIG. 8 is a cross sectional view of FIG. 7.

### DETAILED DESCRIPTION OF THE PREFERRED EMBODIMENTS

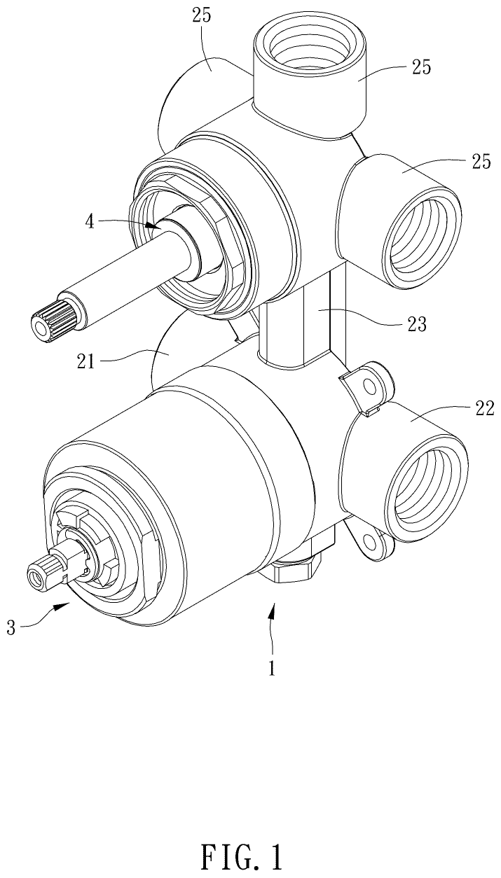

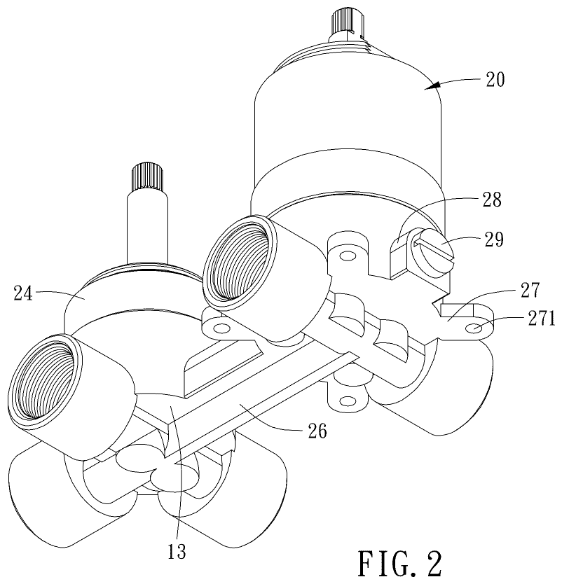

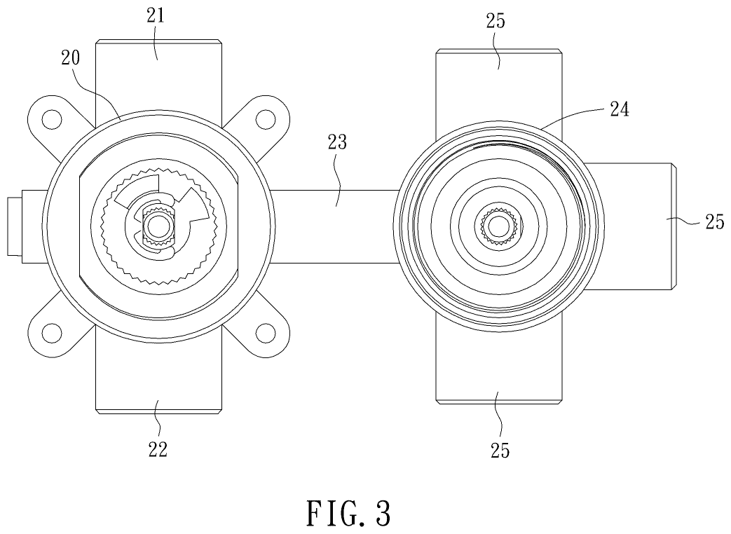

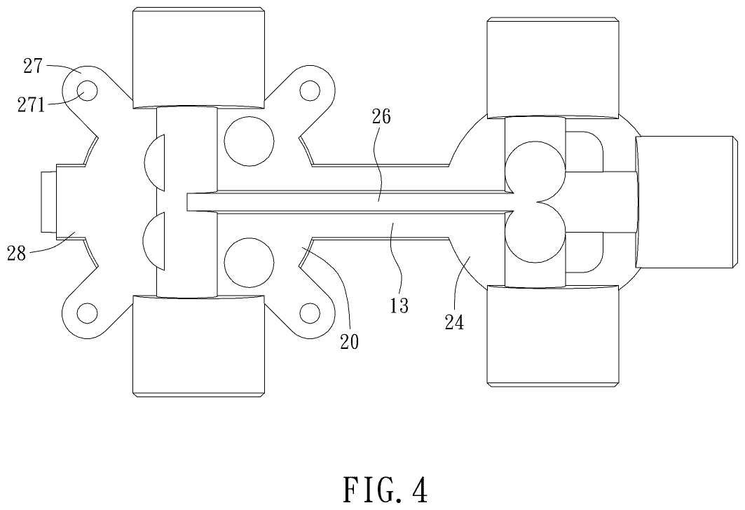

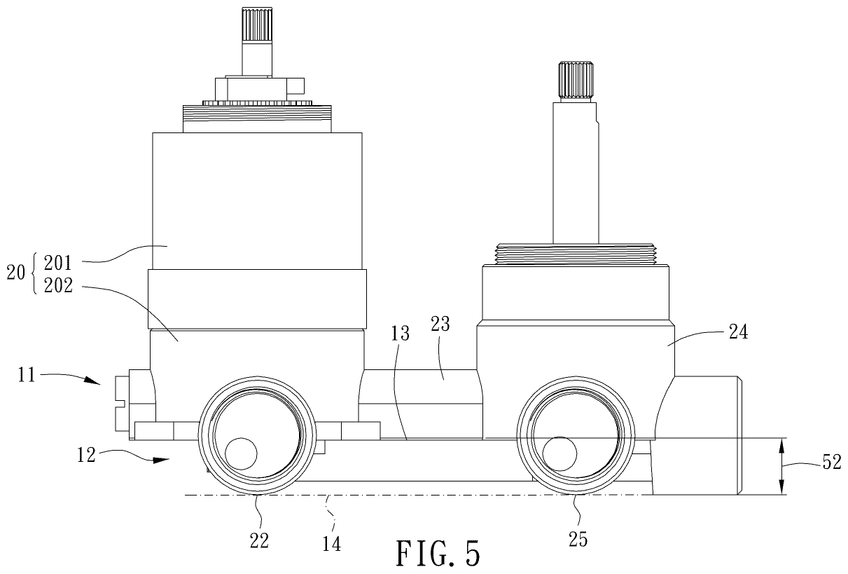

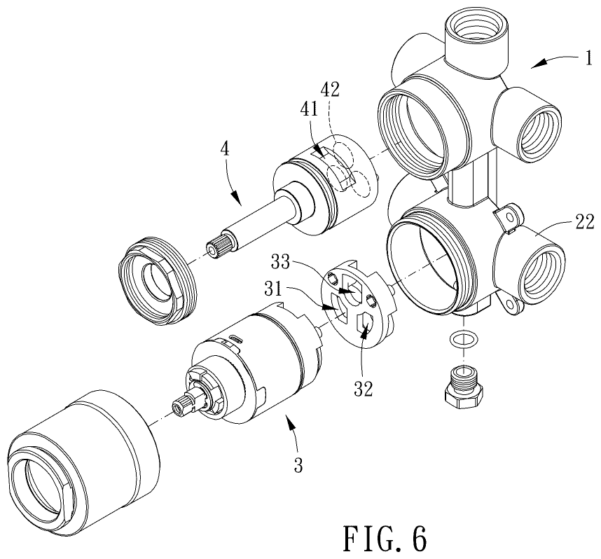

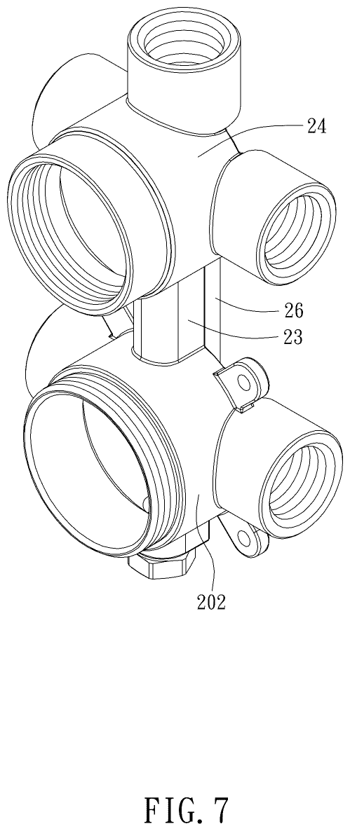

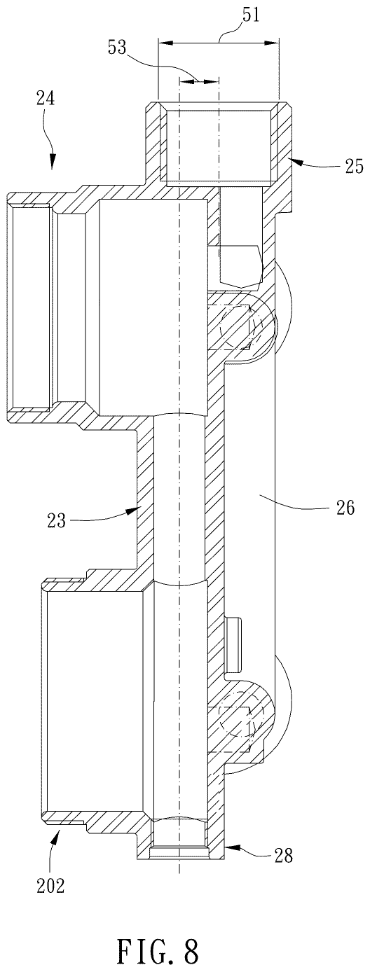

Please refer to FIGS. 1 to 8 for a preferable embodiment of the present invention. A fluid valve of the present invention is suitable for use in modern sanitary equipment and multifunctional faucet systems. The fluid valve includes a valve seat 1, a mixing valve core 3 and a diverter valve core 4.

The valve seat 1 includes a first accommodating portion 20, a hot water tube portion 21, a cold water tube portion 22, a connecting tube portion 23, a second accommodating portion 24 and at least two outlet tube portions 25. The hot water tube portion 21 and the cold water tube portion 22 are respectively communicated with an interior of the first accommodating portion 20, and the connecting tube portion 23 is communicated with the interior of the first accommodating portion 20 and an interior of the second accommodating portion 24. An inner diameter of the connecting tube portion 23 is smaller than an inner diameter of the hot water tube portion 21, and the second accommodating portion 24 is respectively communicated with the at least two outlet tube portions 25.

The mixing valve core 3 is received in the first accommodating portion 20, and the mixing valve core 3 includes a hot water inlet 31, a cold water inlet 32 and a first mixed water outlet 33. The hot water inlet 31 is communicated with the hot water tube portion 21, the cold water inlet 32 is communicated with the cold water tube portion 22, and the first mixed water outlet 33 is communicated with the connecting tube portion 23. Therefore, mixed water can flow out of the mixing valve core 3 from the first mixed water outlet 33 and flow into the second accommodating portion 24 through the connecting tube portion 23. The diverter valve core 4 is received in the second accommodating portion 24, and the diverter valve core 4 includes at least one mixed water inlet 41 and at least two second mixed water outlets 42. The at least one mixed water inlet 41 is communicated with the interior of the second accommodating portion 24, and the at least two second mixed water outlets 42 are respectively communicated with the at least two outlet tube portions 25. Accordingly, the mixed water may be selectively diverted by user's control, such as to a single outlet or multiple outlets.

Specifically, the fluid valve integrates the mixing valve core 3 and the diverter valve core 4 into the valve seat 1, effectively reducing installation complexity and time. In addition, the valve seat 1 is configured with the connecting tube portion 23 for water to flow from the mixing valve core 3 to the diverter valve core 4, eliminating the need to install additional external pipelines. The valve seat 1 ensures smooth water flow without pressure loss, reduces time and cost of installing external piping and sealing components, and eliminates the risk of leakage due to long-term use of external pipe joints.

A configuration of the fluid valve simplifies the number and structure of installation components, shortens installation time, optimizes water flow routing, and avoids leakage issues. Furthermore, it allows users to independently control the mixing valve core 3 and the diverter valve core 4, and facilitates separate replacement of these cores.

Specifically, the first accommodating portion 20 and the second accommodating portion 24 are respectively cylindrical in shape. An outer diameter of the first accommodating portion 20 is greater than an outer diameter of the second accommodating portion 24. The connecting tube portion 23 extends linearly and connects the first accommodating portion 20 with the second accommodating portion 24, and a centerline of the connecting tube portion 23 passes through a center of the first accommodating portion 20 and a center of the second accommodating portion 24. Moreover, the first accommodating portion 20 includes a first component 201 and a second component 202, and the first component 201 is detachably assembled with the second component 202. The second component 202, the hot water tube portion 21, the cold water tube portion 22, the connecting tube portion 23, the second accommodating portion 24 and the at least two outlet tube portions 25 are integrally formed as one piece, which greatly reduces a number of components and effectively prevents leakage caused by assembly.

In this embodiment, the valve seat 1 further includes a protruding tube portion 28 and a plug member 29, and the protruding tube portion 28 protrudes from a side of the first accommodating portion 20 facing away from the second accommodating portion 24. A passage of the protruding tube portion 28 is coaxially arranged with a passage of the connecting tube portion 23, and the plug member 29 is removably disposed on the protruding tube portion 28. For example, the plug member 29 is screwingly connected to the protruding tube portion 28. The design of the protruding tube portion 28 facilitates drilling during production and also serves as a discharge opening during cleaning for discharging debris.

A surface of the first accommodating portion 20, a surface of the connecting tube portion 23, and a surface of the second accommodating portion 24 are located on the same horizontal plane defined as a reference plane 13. The reference plane 13 provides a continuous and stable surface for contact with surrounding objects in use, reducing unintended shaking of the fluid valve. The reference plane 13 divides the valve seat 1 into a first side 11 and a second side 12, the first accommodating portion 20, the connecting tube portion 23 and the second accommodating portion 24 are located on the first side 11, and at least a portion of the hot water tube portion 21, at least a portion of the cold water tube portion 22, and at least a portion of the at least two outlet tube portions 25 are located on the second side 12.

Preferably, in a direction vertical to the reference plane 13, outmost surfaces of the hot water tube portion 21, the cold water tube portion 22 and the at least two outlet tube portions 25 protrude beyond the reference plane 13 by the same distance and are at least partially located on the same horizontal plane which is defined as an abutment plane 14. The abutment plane 14 is parallel to the reference plane 13 and serves as a reference for placement and installation of the fluid valve. Moreover, a distance between the reference plane 13 and the abutment plane 14 can be controlled during manufacturing, providing space for liquid channels, receiving other components, or facilitating heat dissipation.

In this embodiment, maximum inner diameters of the hot water tube portion 21, the cold water tube portion 22 and each of the at least two outlet tube portions 25 are all the same and correspond to a first dimension 51, the distance between the abutment plane 14 and the reference plane 13 corresponds to a second dimension 52, and the second dimension 52 is smaller than or equal to the first dimension 51. Additionally, a centerline of each of the at least two outlet tube portions 25 is closer to the reference plane 13 than the centerline of the connecting tube portion 23. In the direction vertical to the reference plane 13, a distance between the centerline of the connecting tube portion 23 and the centerline of one of the at least two outlet tube portions 25 corresponds to a third dimension 53, and the third dimension 53 is smaller than the second dimension 52.

The valve seat 1 further includes a reinforcing rib 26, and the reinforcing rib 26 protrudes from the reference plane 13 and is located on the second side 12. The reinforcing rib 26 extends from the surface of the first accommodating portion 20 to the surface of the second accommodating portion 24, thereby locally reinforcing a structural strength of the valve seat 1.

The valve seat 1 further includes a plurality of protruding lugs 27 protruding from the first accommodating portion 20. Each of the plurality of protruding lugs 27 has a positioning hole 271 disposed therethrough, and each of the plurality of positioning hole 271 is configured for a positioning member (e.g., a bolt) to be disposed therethrough for securing to a wall or other location.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fluid valve, including:
a valve seat, including a first accommodating portion, a hot water tube portion, a cold water tube portion, a connecting tube portion, a second accommodating portion and at least two outlet tube portions, the hot water tube portion and the cold water tube portion respectively communicated with an interior of the first accommodating portion, the connecting tube portion communicated with the interior of the first accommodating portion and an interior of the second accommodating portion, the second accommodating portion respectively communicated with the at least two outlet tube portions;
a mixing valve core, received in the first accommodating portion, including a hot water inlet, a cold water inlet and a first mixed water outlet, the hot water inlet communicated with the hot water tube portion, the cold water inlet communicated with the cold water tube portion, the first mixed water outlet communicated with the connecting tube portion; and
a diverter valve core, received in the second accommodating portion, including at least one mixed water inlet and at least two second mixed water outlets, the at least one mixed water inlet communicated with the interior of the second accommodating portion, the at least two second mixed water outlets respectively communicated with the at least two outlet tube portions.

2. The fluid valve of claim 1, wherein the first accommodating portion and the second accommodating portion are respectively cylindrical in shape, the connecting tube portion extends linearly and connects the first accommodating portion with the second accommodating portion, and a centerline of the connecting tube portion passes through a center of the first accommodating portion and a center of the second accommodating portion.

3. The fluid valve of claim 1, wherein the valve seat further includes a protruding tube portion and a plug member, the protruding tube portion protrudes from a side of the first accommodating portion facing away from the second accommodating portion, a passage of the protruding tube portion is coaxially arranged with a passage of the connecting tube portion, and the plug member is removably disposed on the protruding tube portion.

4. The fluid valve of claim 1, wherein a surface of the first accommodating portion, a surface of the connecting tube portion and a surface of the second accommodating portion are located on the same horizontal plane which is defined as a reference plane, the valve seat is divided into a first side and a second side by the reference plane, the first accommodating portion, the connecting tube portion and the second accommodating portion are located on the first side, and at least a portion of the hot water tube portion, at least a portion of the cold water tube portion and at least of a portion of the at least two outlet tube portions are located on the second side.

5. The fluid valve of claim 4, wherein in a direction vertical to the reference plane, outmost surfaces of the hot water tube portion, the cold water tube portion and the at least two outlet tube portions protrude beyond the reference plane by the same distance and are at least partially located on the same horizontal plane which is defined as an abutment plane.

6. The fluid valve of claim 5, wherein maximum inner diameters of the hot water tube portion, the cold water tube portion and each of the at least two outlet tube portions are all the same and correspond to a first dimension, a distance between the abutment plane and the reference plane corresponds to a second dimension, and the second dimension is smaller than or equal to the first dimension.

7. The fluid valve of claim 4, wherein the valve seat further includes a reinforcing rib, the reinforcing rib protrudes from the reference plane and is located on the second side, and the reinforcing rib extends from the surface of the first accommodating portion to the surface of the second accommodating portion.

8. The fluid valve of claim 4, wherein a centerline of each of the at least two outlet tube portions is closer to the reference plane than a centerline of the connecting tube portion.

9. The fluid valve of claim 1, wherein the valve seat further includes a plurality of protruding lugs protruding from the first accommodating portion, each of the plurality of protruding lugs has a positioning hole disposed therethrough, and the positioning hole is configured for a positioning member to be disposed therethrough.

10. The fluid valve of claim 6, wherein the first accommodating portion and the second accommodating portion are respectively cylindrical in shape, the connecting tube portion extends linearly and connects the first accommodating portion with the second accommodating portion, and a centerline of the connecting tube portion passes through a center of the first accommodating portion and a center of the second accommodating portion; the valve seat further includes a protruding tube portion and a plug member, the protruding tube portion protrudes from a side of the first accommodating portion facing away from the second accommodating portion, a passage of the protruding tube portion is coaxially arranged with a passage of the connecting tube portion, and the plug member is removably disposed on the protruding tube portion; the valve seat further includes a reinforcing rib, the reinforcing rib protrudes from the reference plane and is located on the second side, and the reinforcing rib extends from the surface of the first accommodating portion to the surface of the second accommodating portion; the valve seat further includes a plurality of protruding lugs protruding from the first accommodating portion, each of the plurality of protruding lugs has a positioning hole disposed therethrough, and the positioning hole is configured for a positioning member to be disposed therethrough; a centerline of each of the at least two outlet tube portions is closer to the reference plane than the centerline of the connecting tube portion; an outer diameter of the first accommodating portion is greater than an outer diameter of the second accommodating portion; the first accommodating portion includes a first component and a second component, the first component is detachably assembled with the second component, the second component, the hot water tube portion, the cold water tube portion, the connecting tube portion, the second accommodating portion and the at least two outlet tube portions are integrally formed as one piece; the plug member is screwingly connected to the protruding tube portion; in the direction vertical to the reference plane, a distance between the centerline of the connecting tube portion and the centerline of one of the at least two outlet tube portions corresponds to a third dimension, the third dimension is smaller than the second dimension; and an inner diameter of the connecting tube portion is smaller than an inner diameter of the hot water tube portion.
